(19) United States
(12) Patent Application Publication
(10) Pub. No.: US 2015/0055337 A1
(43) Pub. Date: Feb. 26, 2015

(54) LIGHT-EMITTING DEVICE

(71) Applicant: Lextar Electronics Corporation, Hsinchu (TW)

(72) Inventors: Liang-Ta LIN, Guishan Township (TW); Kuo-Chan HUNG, Taipei City (TW)

(73) Assignee: Lextar Electronics Corporation, Hsinchu (TW)

(21) Appl. No.: 14/253,077

(22) Filed: Apr. 15, 2014

(30) Foreign Application Priority Data
Aug. 20, 2013 (TW) 102129829

(51) Int. Cl. F21K 99/00

(52) U.S. Cl. CPC F21K 9/56
USPC 362/231

(57) ABSTRACT

Disclosed herein is a light-emitting device that includes a blue light source, a first phosphor and a red light source. The blue light source emits blue light. The first phosphor is excited by the blue light to emit light that is then combined with the blue light to produce first white light. The first white light falls in a first region of (0.397, 0.502), (0.337, 0.512), (0.26, 0.34), and (0.313, 0.3334), based on a CIE 1931 color coordinate standard. The red light source emits red light to adjust the first white light into second white light.

### RELATED APPLICATIONS

This application claims priority to Taiwan Application Serial Number 102129829, filed Aug. 20, 2013, which is herein incorporated by reference.

### BACKGROUND

1. Field of Invention

The present invention relates to light-emitting devices. More particularly, the present invention relates to light-emitting diode devices.

2. Description of Related Art

A light-emitting diode (LED) is a semiconductor light source. LEDs are used as indicator lamps in many devices and are increasingly used for general lighting. Appearing as practical electronic components in 1962, early LEDs emitted low-intensity red light, but modern LEDs are available across the visible, ultraviolet, and infrared wavelengths, with very high brightness.

When a light-emitting diode is switched on, electrons are able to recombine with holes within the device, releasing energy in the form of photons. This effect is called electro-luminescence, and the color of the light (corresponding to the energy of the photon) is determined by the energy band gap of the semiconductor. LEDs have many advantages over incandescent light sources including lower energy consumption, longer lifetime, improved physical robustness, smaller size, and faster switching. Further, because of the advanced efficiency of white LED and the drop of LED price, the development of the white-light LED leads to wide use for illumination, and is slowly replacing incandescent and fluorescent lighting. However, the target color temperature of a current white LED is often limited to 4000K or less, and this white LED is not designed for a backlight module.

In view of the foregoing, there exist problems and disadvantages in the related art for further improvement; however, those skilled in the art sought vainly for a suitable solution. In order to solve or circumvent above problems and disadvantages, there is an urgent need in the related field to provide a LED light mixing technology with high color rendering for illumination and wide color gamut for backlight.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides light-emitting devices to solve or circumvent aforesaid problems and disadvantages.

In one embodiment, a light-emitting device includes a blue light source, a first phosphor and a red light source. The blue light source is configured to emit blue light. The first phosphor is excited by the blue light to emit light and then the light is combined with the blue light to produce first white light. The first white light falls in a first region of (0.397, 0.502), (0.337, 0.512), (0.26, 0.34), and (0.313, 0.3334), based on a CIE 1931 color coordinate standard. The red light source is configured to emit red light to adjust the first white light into second white light.

In one embodiment, the second white light falls in a second region of (0.52, 0.512), (0.337, 0.512), (0.26, 0.34), and (0.39, 0.26), based on the CIE 1931 color coordinate standard.

In one embodiment, the second white light covers neutral white light and warm white light.

In one embodiment, the blue light source includes at least one blue LED chip.

In one embodiment, the blue light has a wavelength range from 440 to 470 nm.

In one embodiment, the light from the first phosphor excited by the blue light has a wavelength range from 540 to 565 nm.

In one embodiment, the red light source includes at least one red LED chip.

In one embodiment, the red light has a wavelength range from 580 to 640 nm.

In one embodiment, the light-emitting device further includes a second phosphor. The second phosphor is excited by the blue light to emit light having a wavelength that is greater than or equal to a wavelength of the red light.

In one embodiment, a light-emitting device includes a blue light source, a third phosphor and a red light source. The blue light source is configured to emit blue light. The third phosphor is excited by the blue light to emit light and then the light is combined with the blue light to produce third white light. The third white light falls in a third region of (0.18, 0.22), (0.23, 0.20), (0.25, 0.35), and (0.19, 0.37), based on a CIE 1931 color coordinate standard. The red light source is configured to emit red light to adjust the third white light into fourth white light.

In one embodiment, the fourth white light falls in a fourth region of (0.18, 0.22), (0.39, 0.13), (0.42, 0.35), and (0.19, 0.37), based on the CIE 1931 color coordinate standard.

In one embodiment, the third white light covers neutral white light and warm white light.

In one embodiment, the blue light source includes at least one blue LED chip.

In one embodiment, the blue light has a wavelength range from 440 to 470 nm.

In one embodiment, the light from the third phosphor excited by the blue light has a wavelength range from 515 to 540 nm.

In one embodiment, the red light source includes at least one red LED chip.

In one embodiment, the red light has a wavelength range from 580 to 640 nm.

In one embodiment, the light-emitting device further includes a fourth phosphor. The fourth phosphor is excited by the blue light to emit light having a wavelength that is greater than or equal to a wavelength of the red light.

In view of the above, the present disclosure is related to an improvement in the LED light mixing technology for setting a chromaticity range of white light. In this way, the light-emitting device has high color rendering for illumination and/or wide color gamut for backlight.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic cross-section view of a light-emitting device according to one embodiment of the present disclosure;

FIG. 2 is a CIE1931 color coordinate graph illustrating a first region according to one embodiment of the present disclosure;

FIG. 3 is a CIE1931 color coordinate graph illustrating first and second regions according to one embodiment of the present disclosure;

FIG. 4 are spectrograms illustrating first white light, red light, and second light according to one embodiment of the present disclosure;

FIG. 5 is a schematic cross-section view of a light-emitting device according to another embodiment of the present disclosure;

FIG. 6 is a CIE1931 color coordinate graph illustrating a third region according to another embodiment of the present disclosure; and

FIG. 7 is a CIE1931 color coordinate graph illustrating third and fourth regions according to another embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

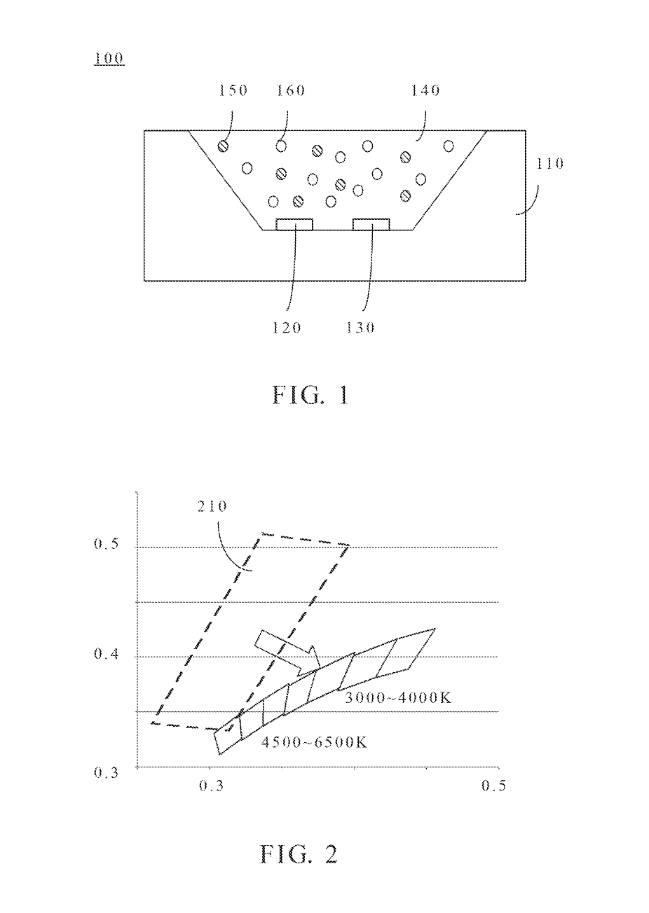

In one aspect, the present disclosure is related to a light-emitting device that can be applicable or readily adaptable to an illuminator. FIG. 1 is a schematic cross-section view of a light-emitting device 100 according to one embodiment of the present disclosure. As illustrated in FIG. 1, the light-emitting device 100 includes a main body 110, a blue light source 120, a red light source 130, an encapsulation material 140 and first phosphor 150.

Structurally, the main body 110 may be a package body including a lead frame and has a cavity to serves as a package space, so that the blue light source 120 and the red light source 130 can be disposed in the main body 110. The first phosphor 150 is mixed with the encapsulation material 140, and the blue light source 120 and the red light source 130 are covered with the encapsulation material 140. For example, the encapsulation material 140 is allowed light to pass through, such as silicon resin, epoxy, silicone, other suitable materials, or a combination of the above.

In use, the blue light source 120 emits blue light, and the first phosphor 150 is excited by the blue light to emit light and then the light is combined with the blue light to produce first white light. The red light source 130 emits red light, and the red light adjusts the first white light into second white light.

In one embodiment, the blue light source 120 includes at least one blue LED chip, in which the blue light has a wavelength range from 440 to 470 nm. The first phosphor 150 is excited by this blue light to emit light has a wavelength range from 540 to 565 nm. Thus, white light with various color temperatures can be produced.

In one embodiment, the red light source 130 comprises at least one red LED chip, in which the red light has a wavelength range from 580 to 640 nm for adjusting the first white light into second white light, so that the second white light can cover neutral white light and warm white light.

In FIG. 1, the light-emitting device 100 further includes second phosphor 160. The second phosphor 160 is mixed with the encapsulation material 140. The second phosphor 160 is excited by the blue light to emit light having a wavelength that is greater than or equal to a visible light wavelength of the red light.

For a more complete understanding of the range of the first white light, and the advantages thereof, please refer to FIG. 2. FIG. 2 is a CIE1931 color coordinate graph illustrating a first region 210 of the first white light according to one embodiment of the present disclosure. As illustrated in FIG. 2, the first white light falls in the first region 210 of (0.397, 0.502), (0.337, 0.512), (0.26, 0.34), and (0.313, 0.3334), based on a CIE 1931 color coordinate standard. Thus, the red light adjusts the first white light into the second white light that is capable of covering neutral white light (color temperature: 4500-6500K) and warm white light (color temperature: 3000-4000K).

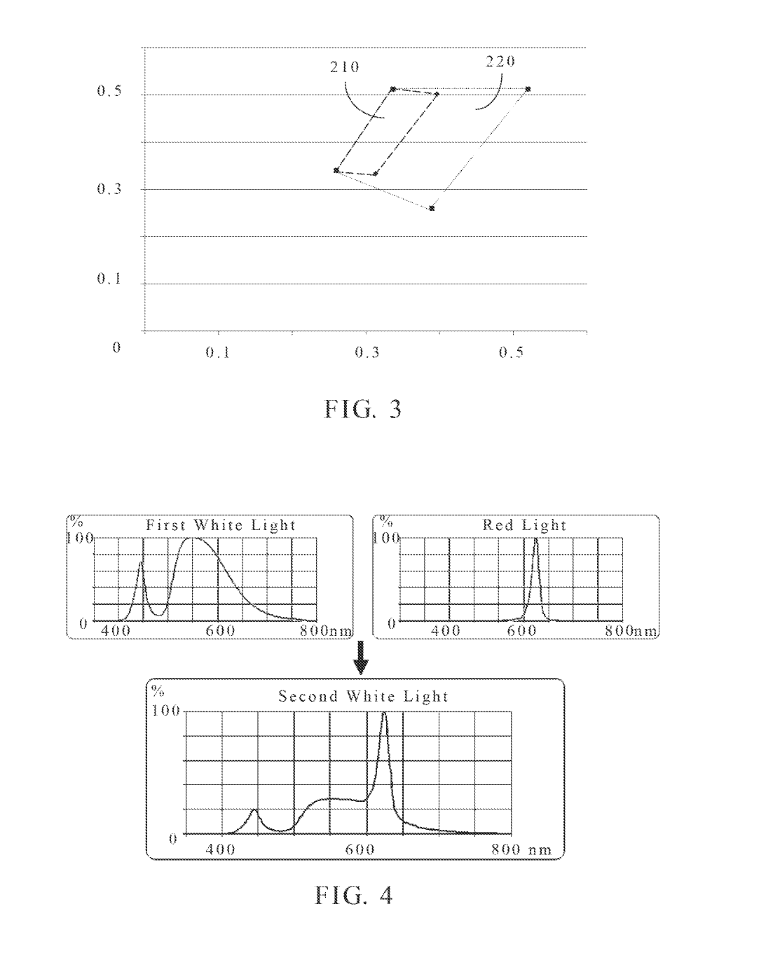

In addition, for a more complete understanding of the range of the second white light, and the advantages thereof, please refer to FIGS. 3 and 4. FIG. 3 is a CIE1931 color coordinate graph illustrating the first region 210 of the first white light and a second region 220 of the second white light, and spectrograms of first white light, red light, and second light are illustrated in FIG. 4, where the red light adjusts the first white light into the second white light. As illustrated in FIG. 3, the first white light falls in the first region 210 of (0.397, 0.502), (0.337, 0.512), (0.26, 0.34), and (0.313, 0.3334) and the second white light falls in the second region 220 of (0.52, 0.512), (0.337, 0.512), (0.26, 0.34), and (0.39, 0.26), based on the CIE 1931 color coordinate standard. The second region 220 of the second white light covers neutral white light and warm white light, thereby improving color rendering for illumination.

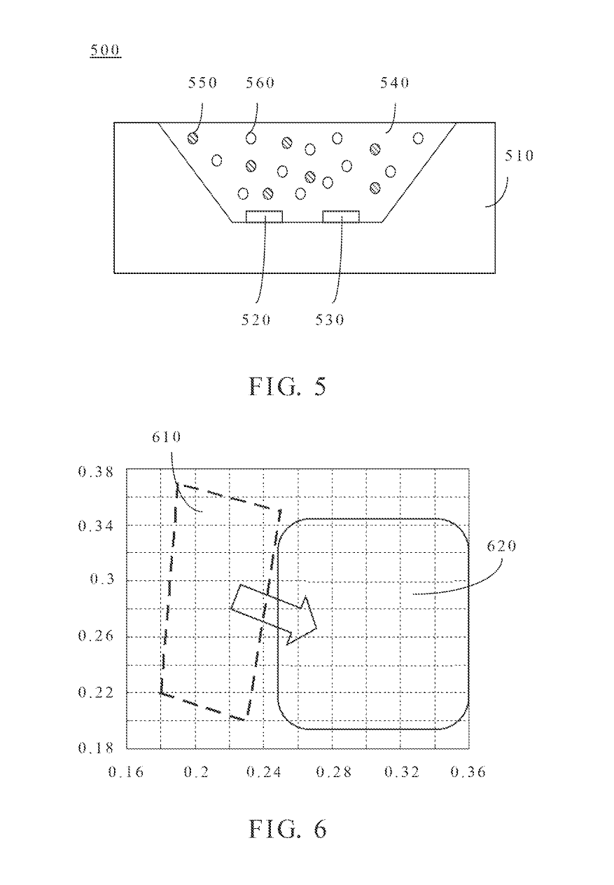

In another aspect, the present disclosure is related to a light-emitting device that can be applicable or readily adaptable to a backlight module. FIG. 5 is a schematic cross-section view of a light-emitting device 500 according to another embodiment of the present disclosure. As illustrated in FIG. 5, the light-emitting device 500 includes a main body 510, a blue light source 520, a red light source 530, an encapsulation material 540 and third phosphor 550.

Structurally, the main body 510 may be a package body including a lead frame and has a cavity to serves as a package space, so that the blue light source 520 and the red light source 530 can be disposed in the main body 110. The third phosphor 550 is mixed with the encapsulation material 540, and the blue light source 520 and the red light source 530 are covered with the encapsulation material 540. For example, the encapsulation material 540 is allowed light to pass through, such as silicon resin, epoxy, silicone, other suitable materials, or a combination of the above.

In use, the blue light source 520 emits blue light, and the third phosphor 550 is excited by the blue light to emit light that is then combined with the blue light to produce third white light. The red light source 530 emits red light, and the red light adjusts the first white light into fourth white light.

In one embodiment, the blue light source 520 includes at least one blue LED chip, in which the blue light has a wavelength range from 440 to 470 nm. The third phosphor 550 is excited by this blue light to emit light has a wavelength range from 515 to 540 nm. Thus, white light with various color temperatures can be produced.

In one embodiment, the red light source 530 comprises at least one red LED chip, in which the red light has a wavelength range from 580 to 640 nm for adjusting the third white light into fourth white light, so that the fourth white light can cover neutral white light and warm white light.

In FIG. 5, the light-emitting device 100 further includes fourth phosphor 160. The fourth phosphor 560 is mixed with the encapsulation material 540. The fourth phosphor 560 is excited by the blue light to emit light having a wavelength that is greater than or equal to a visible light wavelength of the red light.

For a more complete understanding of the range of the third white light, and the advantages thereof, please refer to FIG. 6. FIG. 6 is a CIE1931 color coordinate graph illustrating a third region 610 of the third white light according to one embodiment of the present disclosure. As illustrated in FIG. 6, the third white light falls in the third region 610 of (0.18, 0.22), (0.23, 0.20), (0.25, 0.35), and (0.19, 0.37), based on the CIE 1931 color coordinate standard. Thus, the red light adjusts the third white light into the fourth white light that is in a color region 620 often used in the backlight.

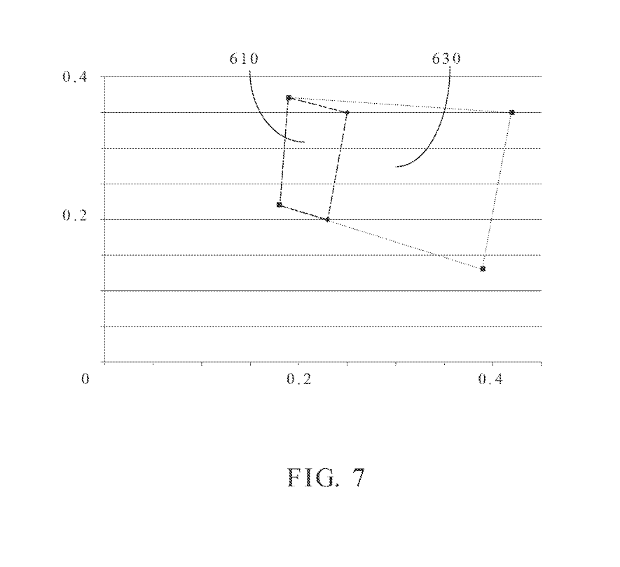

In addition, for a more complete understanding of the range of the fourth white light, and the advantages thereof, please refer to FIG. 7. FIG. 7 is a CIE1931 color coordinate graph illustrating the third region 610 of the third white light and a fourth region 630 of the fourth white light. In practice, the red light adjusts the third white light into the fourth white light. As illustrated in FIG. 7, the third white light falls in the third region 610 of (0.18, 0.22), (0.23, 0.20), (0.25, 0.35), and (0.19, 0.37), based on the CIE 1931 color coordinate standard; the fourth white light falling in the fourth region 630 of (0.18, 0.22), (0.39, 0.13), (0.42, 0.35), and (0.19, 0.37), based on the CIE 1931 color coordinate standard. The fourth region 630 of the fourth white light is in the color region of backlight, so as to accomplish the wide color gamut for the backlight module.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A light-emitting device, comprising:
a blue light source configured to emit blue light;
a first phosphor excited by the blue light to emit light that is then combined with the blue light to produce first white light, and the first white light falling in a first region of (0.397, 0.502), (0.337, 0.512), (0.26, 0.34), and (0.313, 0.3334), based on a CIE 1931 color coordinate standard; and
a red light source configured to emit red light to adjust the first white light into second white light.

2. The light-emitting device of claim 1, wherein the second white light falls in a second region of (0.52, 0.512), (0.337, 0.512), (0.26, 0.34), and (0.39, 0.26), based on the CIE 1931 color coordinate standard.

3. The light-emitting device of claim 1, wherein the second white light covers neutral white light and warm white light.

4. The light-emitting device of claim 1, wherein the blue light source comprises at least one blue light-emitting diode (LED) chip.

5. The light-emitting device of claim 4, wherein the blue light has a wavelength range from 440 to 470 nm.

6. The light-emitting device of claim 4, wherein the light from the first phosphor excited by the blue light has a wavelength range from 540 to 565 nm.

7. The light-emitting device of claim 1, wherein the red light source comprises at least one red LED chip.

8. The light-emitting device of claim 7, wherein the red light has a wavelength range from 580 to 640 nm.

9. The light-emitting device of claim 1, further comprising:
a second phosphor excited by the blue light to emit light having a wavelength that is greater than or equal to a wavelength of the red light.

10. A light-emitting device, comprising:
a blue light source configured to emit blue light;
a third phosphor excited by the blue light to emit light that is then combined with the blue light to produce third white light, and the third white light falling in a third region of (0.18, 0.22), (0.23, 0.20), (0.25, 0.35), and (0.19, 0.37), based on a CIE 1931 color coordinate standard; and
a red light source configured to emit red light to adjust the third white light into fourth white light.

11. The light-emitting device of claim 10, wherein the fourth white light falls in a fourth region of (0.18, 0.22), (0.39, 0.13), (0.42, 0.35), and (0.19, 0.37), based on the CIE 1931 color coordinate standard.

12. The light-emitting device of claim 10, wherein the third white light covers neutral white light and warm white light.

13. The light-emitting device of claim 10, wherein the blue light source comprises at least one blue LED chip.

14. The light-emitting device of claim 13, wherein the blue light has a wavelength range from 440 to 470 nm.

15. The light-emitting device of claim 14, wherein the light from the third phosphor excited by the blue light has a wavelength range from 515 to 540 nm.

16. The light-emitting device of claim 10, wherein the red light source comprises at least one red LED chip.

17. The light-emitting device of claim 16, wherein the red light has a wavelength range from 580 to 640 nm.

18. The light-emitting device of claim 10, further comprising:
a fourth phosphor excited by the blue light to emit light having a wavelength that is greater than or equal to a wavelength of the red light.
